(19) United States
(12) Patent Application Publication
(10) Pub. No.: US 2016/0086295 A1
(43) Pub. Date: Mar. 24, 2016

(54) METHOD AND APPARATUS FOR ESTIMATING HOME REMODELING COSTS

(71) Applicant: Houzz, Inc., Palo Alto, CA (US)

(72) Inventors: Alon COHEN, Palo Alto, CA (US); Ofir ZWEBNER, Mountain View, CA (US)

(21) Appl. No.: 14/956,357

(22) Filed: Dec. 1, 2015

Related U.S. Application Data
(62) Division of application No. 14/176,017, filed on Feb. 7, 2014.
(60) Provisional application No. 61/762,046, filed on Feb. 7, 2013.

(51) Int. Cl. G06Q 50/16

(52) U.S. Cl. CPC G06Q 50/165

(57) ABSTRACT

A home remodeling cost estimator tool is used to create a cost breakdown for use when remodeling a house or a room, based on user interaction with photos, for example from such sites as Houzz.com and other proprietary data sources. For any photo in a photo database for such design sites, a user can work with the estimator to generate a price estimate and a breakdown for a building project.

### CROSS REFERENCE TO RELATED APPLICATIONS

This application is a divisional of U.S. patent application Ser. No. 14/176,017, filed Feb. 7, 2014, which application claims priority to provisional patent application Ser. No. 61/762,046, filed Feb. 7, 2013, each of which is incorporated herein in its entirety by this reference thereto.

### BACKGROUND OF THE INVENTION

1. Technical Field

The invention relates to home remodeling. More particularly, the invention relates for estimation tools for use in connection with home remodeling.

2. Description of the Background Art

Buying a jug of milk or a loaf of bread is straightforward because the price is clearly marked. Even products that have negotiable prices, such as cars and properties, can at least be seen, touched, and inspected before they are bought. But when a building or remodeling project is undertaken, pricing is much more difficult to determine. For example, it is likely that the project has never been built elsewhere in exactly the same size, finishes, circumstances, and location. That makes the project entirely custom and that means the price is, too.

Arriving at a cost for a project involves creating plans and specifications, and requires time, thought, and shopping. The more detailed that the plans are, the more accurate the price.

Currently, price can be determined by having a contractor estimate or bid the project. There are also on-line tools which provide a dialog that asks a user questions about the project, for example, by filling in an on-line form. This information is then forwarded to a contractor who completes the estimate or bid using conventional techniques.

At its core, every price a contractor provides is an estimate of the labor and materials needed to complete the project. In residential construction an estimate, also known as a bid, generally is not a firm price. Estimates and bids are only as accurate as the information upon which they are based. For instance, the least accurate estimate is based upon square-foot pricing, a range of square-foot pricing, or a typical cost for projects of that type. The result does not reflect actual cost, but it can provide a likely price with regard to cost expectations.

This level of accuracy also means that there is likely to be a wide range of estimated costs when consulting with multiple contractors because each contractor has a different interpretation of what the project entails and each contractor employs a different approach when creating an estimate.

The difficulty in arriving at accurate cost estimates for such projects is further complicated by such factors as city, county, state, and country regulations, which may have an additional financial impact on the cost of the project that is often not clear to both the contractor and the homeowner when evaluating the project.

With a floor plan and a general idea of engineering and finishes, a more accurate line item estimate can be created, but it is still a rough order of magnitude. Such estimates typically entail allowances based on square foot and unit costs, and extrapolation from other projects of similar size. This approach is useful in narrowing down and selecting a contractor, but it does not indicate the exact cost of the project. This is particularly important to note because this approach does not take into account finishes, such as fixtures, tile and paint, and the like, which can add significantly to the cost of the project.

For the highest level of accuracy in an estimate, engineering must be completed and reflected in a construction plan; all finishes should be selected; and all bids should be secured from all the subcontractors. This final estimate usually has dozens of line items with specific costs for materials, labor, and subcontractors, which show the source of all of the fees and how they add up to the bottom line. Because this level of estimating takes so much staff time, many contractors only provide this type of estimate once they are hired for the project.

When a contractor uses this estimate as a basis for a construction contract, it is usually called a time and materials or cost plus contract. The “plus” in the estimate is a contractor's markup for overhead, sometimes called a contractor's fee, that is applied to some or all of the costs of the project.

The alternative to an estimate is a bid, which means the contractor or subcontractor agrees to complete a specific scope of work for a firm price. If it costs less to finish the work, the contractor makes more money. If it costs more, the contractor could make less profit or even lose money on the job.

A bid typically provides a bottom-line cost for the project, with a payment schedule based on either time or milestones. The price includes a markup that covers the contractor's overhead, but that is generally not shown as a separate cost. On very large projects, the bid might be accompanied by categorized costs, e.g. mechanical, framing, finishes, etc., that also show the contractor's fee.

For the bid to be meaningful, it should be tied to clear specifications and plans, which is essentially the same documentation found in a time and materials contract. It should also clearly state any allowances included in the bid. Allowances are dollar amounts allocated for specific finishes that have not yet been selected, i.e. either materials or labor, or both.

Although a bid contract is for a firm price, it is still subject to change orders for any work that varies from what is specified in the plans.

The level of detail required for a bid means that a firm price is usually not possible early in the planning process. The large amount of staff and subcontractors' time required to complete a bid, particularly on large projects, may also cause some contractors to either charge a fee for providing a bid or decline to bid entirely until they are hired.

Accordingly, there is currently no satisfactory way for a person who is contemplating a remodeling project to identify the cost of the project with any accuracy, including such details as finishes and the like, without working with a contractor; nor can various line items in the project, such as finishes, be selected and replaced to identify their effect on an overall budget established for the project.

As such, there is also no satisfactory way of choosing between alternative remodeling plans. Oftentimes, the homeowner is facing two, three, or more alternative remodeling solutions, each of which is acceptable and desirable, but each of which dictates a different approach and implies a different remodeling cost. Currently, homeowners and contractors are challenged by comparing two or more different plans because producing and estimating the plans is difficult and costly.

### SUMMARY OF THE INVENTION

Embodiments of the invention provide a home remodeling cost estimator. The estimator is a tool for creating a cost breakdown for use when remodeling a house or a room, based on user interaction with photos, for example from such sites as Houzz.com and other proprietary data sources. For any photo in a photo database for such design sites, a user can work with the estimator to generate a price estimate and a breakdown for a building project.

### BRIEF DESCRIPTION OF THE DRAWINGS

FIG. 1 is a screen shot that illustrates how users can filter photos based on projected costs using custom parameters, such as inclusion of labor, material, and/or geo-location, according to the invention;

FIG. 2 is a screen shot showing a view of a particular photo selected at said website related to home design and an estimation tool for use in connection with design elements within said photo according to the invention;

FIG. 3 is a screen shot showing a user dialog in which a user selects a style for use with the estimation tool according to the invention

FIG. 4 is a screen shot showing localized design costs according to the invention;

FIG. 5 is a screen shot that shows user generated content according to the invention;

FIG. 6 is a flow diagram showing the use of an estimation tool according to the invention;

FIG. 7 is a screen shot showing a first step of a user dialog in which a user selects a room for use with the estimation tool according to the invention;

FIG. 8 is a screen shot showing a next step of a user dialog in which a user selects a budget for use with the estimation tool according to the invention;

FIG. 9 is a screen shot showing a next step of a user dialog in which a user is presented with photos for selection in connection with use of the estimation tool according to the invention;

FIG. 10 is a screen shot showing a next step of a user dialog in which a user selects desired elements of a design depicted in a selected photo for use with the estimation tool according to the invention;

FIG. 11 is a screen shot showing an overview of how the project plan looks, thus providing a visually stimulating curation, along with a high-level cost breakdown, according to the invention; and

FIG. 12 is a block schematic diagram showing a machine in the exemplary form of a computer system within which a set of instructions for causing the machine to perform any of the herein disclosed methodologies may be executed.

### DETAILED DESCRIPTION OF THE INVENTION

Embodiments of the invention provide a home remodeling cost estimator. The estimator is a tool for creating a cost breakdown for use when remodeling a house or a room, based on user interaction with photos, for example from such sites as Houzz.com and other proprietary data sources. For any photo in a photo database for such design sites, a user can work with the estimator to generate a price estimate and a breakdown for a building project.

### Core Functionality

### Photo Cost Breakdown

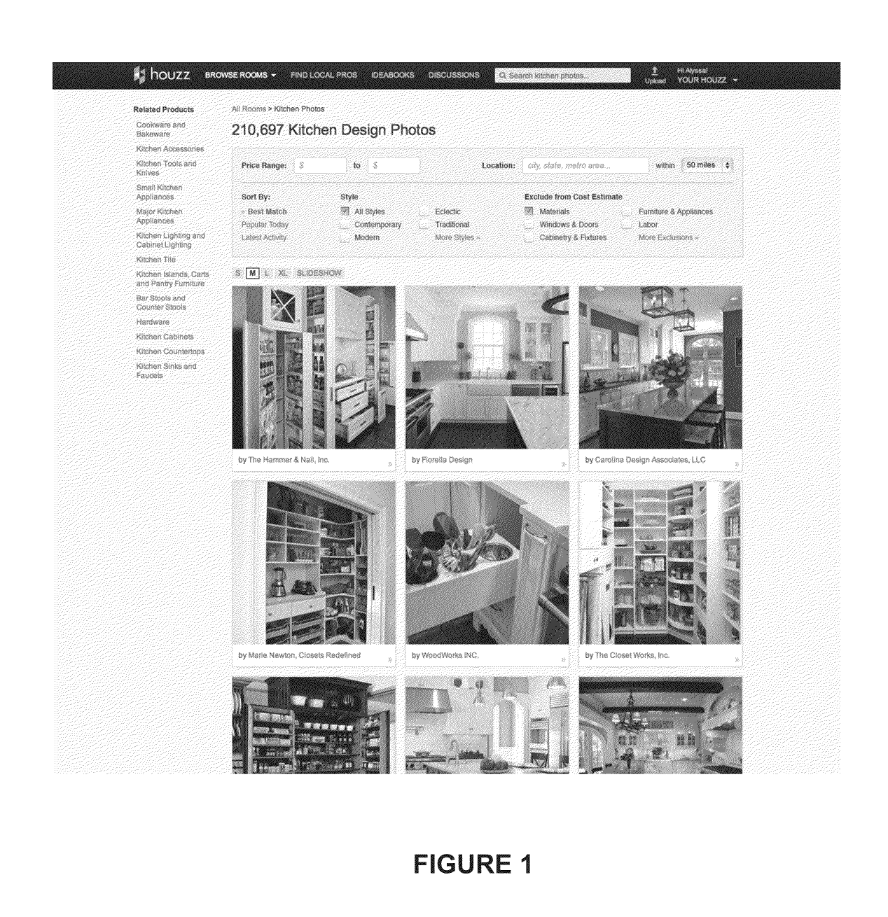

FIG. 1 is a screen shot that illustrates how users can filter photos based on projected costs using custom parameters, such as inclusion of labor, material, and/or geo-location, according to the invention. The following functionality is supported for any given photo:
Component cost breakdowns, including materials, e.g. concrete, drywall, floors, tiles, and paint, and including area and volume measurement and pricing; windows and doors; cabinetry and fixtures, e.g. bathtub, countertop, faucet, and fireplace; furniture and appliances, e.g. sofa, table, fridge, range, and lighting; infrastructure, e.g. plumbing, electricity, and gas; and labor, e.g. demolition, fabrication, framing, installation, and finish;
Construction time estimate, including typical dependencies, e.g. tub installation comes after the plumbing is done;
List of city, county, state, and country regulations and qualifications that are required to perform the task. This is based on the construction site geographic location. Some projects do not require permits, while others require specific permit that takes a certain time to get approved;
List of list of professionals' qualifications required for the job; for example, a kitchen remodel requires qualified electrician, as well as a qualified gas, water, and sewage piping contractor. This is also based on construction site geographic location; and
Total price estimate, based on the above the user can adjust the estimate by removing and/or adding components as applicable to the real-life project.

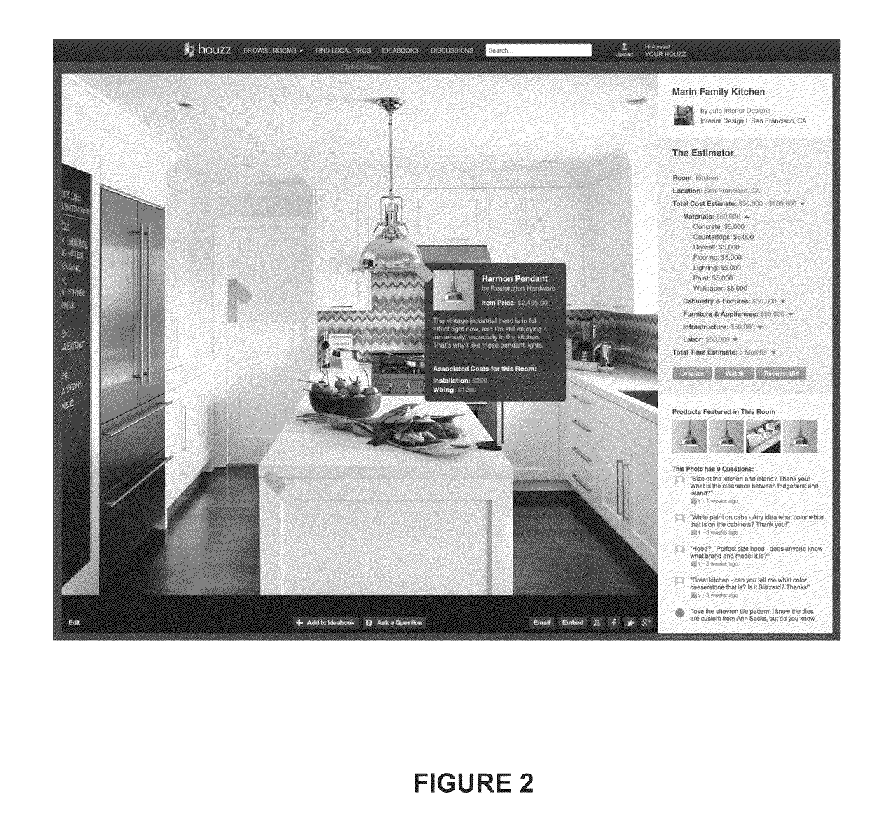

FIG. 2 is a screen shot showing a view of a particular photo selected at said website related to home design and an estimation tool for use in connection with design elements within said photo according to the invention.

The tags shown in the photo are a result of human and software identification of commercial products within the photo. There are links between the photo and the products identified in the photo. This helps inform the breakdown of the costs in the photo, but is not required. Additional breakdown of costs in a photo are provided by any of, for example, automatic product identification, user input, and professional input.

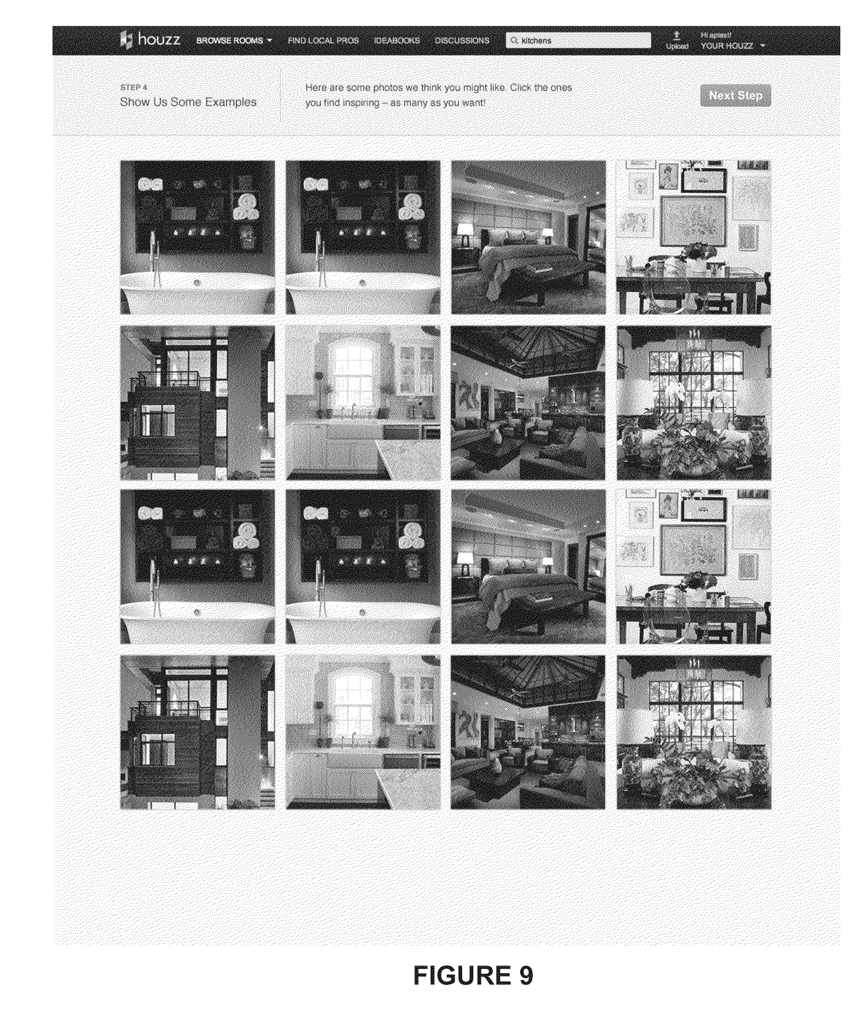

As illustrated in FIG. 9 (discussed below), the user can store multiple photos pertaining to the same room, and mark individual components, e.g. products, materials, treatment, etc. in the photo to construct a compound estimate.

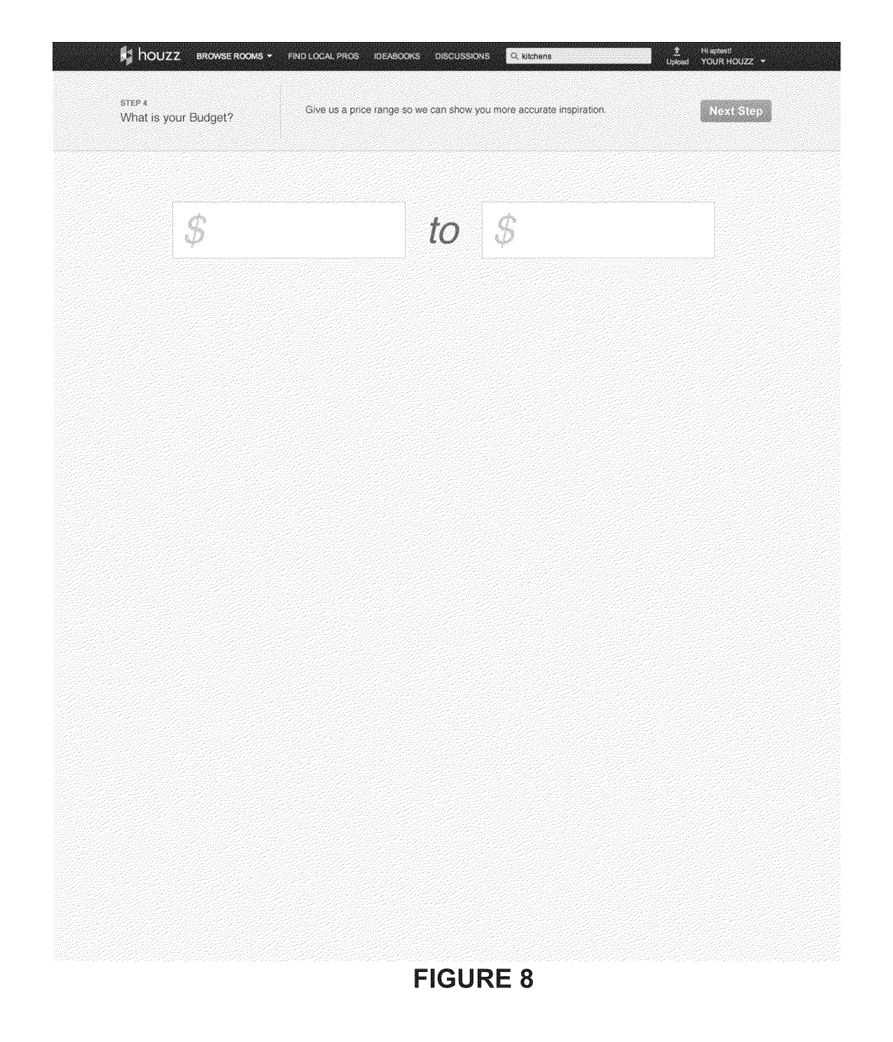

A budget warning can be provided in embodiments of the invention. As long as the user has specified a budget rage within to work, the estimator helps refine the breakdown to assist the user and the contractor in meeting their budgetary goals (see FIG. 8).

Localization is selected at the time of starting the project to allow for best functionality of the estimator, e.g. to provide warnings about permits and other standards. Regardless, budgets and localization can be changed through the process of using the estimator, thus impacting the final budget. This is the same as adding or subtracting a product or choosing a different finish. Every element of the project is open for alteration to help the user arrive at the right solution.

In embodiments of the invention, the estimator is implemented in computer software that combines a database of photos and products with a mechanism for entering data, e.g. user generated content and data sent in from vendors, and for retrieving the data in a flow, thus allowing the user to make selection and construct project cost estimates. A central or distributed server allows for retrieving photos, products, and location data and for storing the user's choices. A Web client, e.g. written in HTML and JavaScript, allows the user to interact with the data visually and to build the cost estimate on a Web browser. Similarly, a mobile application, e.g. written in Objective C, Java, etc., allows the user to interact with the data visually and to build the cost estimate on a mobile or tablet platform, such as a phone or tablet device.

FIG. 2 illustrates how the estimator visualizes, for the user on the Web client or the mobile or tablet application, the photos and the data stored about the photos in the central or distributed server. The data shown is the photo itself, various types of information collected about the photo, such as categorization, location, material costs, furniture costs, etc., and the related products. This information is also stored on the server as separate entities that are linked to the photo.

The user chooses a photo of a kitchen (see FIG. 1). The estimator gives a detailed breakdown of the materials, e.g. volume and prices; cabinet pricing, including countertop, door knobs, shelving; the appliances, e.g. fridge, range, hood, oven, and microwave; lights, e.g. fixtures and switches; and the labor, e.g. laying the floors, installing the cabinets, fabricating the countertop, and installing a panoramic window. The construction time is given, including all the different professionals involved, e.g. general contractor, kitchen installer, and countertop manufacturer. The user can then select and deselect various options based upon relevance to the user's intended project and/or with regard to the user's budget. For example, the user can choose to remove cost of the fridge because it is irrelevant for the project.

### Photo Browsing and Filtering

The photo estimated cost can be used for browsing the photos on a home design site, such as Houzz. Specifically, this allows users to browse remodeling photos that meet their price range. By means of filtering, the user can pick and price components to include in the project. For example, the user has a price range of $20 k-$30 k for remodeling a kitchen; her brother is a contractor and she already has a fridge and dishwasher. By making these filtering choices only the relevant photos show up, which meet the price range and exclude the cost of construction and given appliances.

An alternative approach to explain this is that the photos in the repository all have a complete price cost for the complete work. However, in reality the user may already have their mind and budget set on certain aspects of the project shown in the photo, e.g. appliances and backsplash, and is looking for cabinetry to fit the rest of his budget. The estimator tool allows the user to browse the repository of photos based on a budget applied to a portion of the photo. The user can look through all photos that have, e.g. cabinetry below $30,000, regardless of the total cost of the rooms.

Filtering can be done by all facets of the photos. These facets are determined by:
Type of room, e.g. kitchen, bath, living room;
Style, e.g. modern, contemporary, Asian, etc.;
Room layout, e.g. L-Shape, Island, etc.;
Flooring, e.g. price per square foot, type, material, color;
Lighting, e.g. price. type, color;
Counters, e.g. price per square foot, shape, material, color;
Sink, e.g. price, shape, type, color, material;
Cabinetry, e.g. price, material, color;
Wall treatment, e.g. price, type, color;
Appliances, e.g. price, type, color;
Etc.

Thus, the user can search for all photos with, for example, an under mount sink within $10,000, or all photos that have brushed-metal finished appliances. Once the user finds the photo that fits his needs, the user adds the photo to the estimator and marks the specific feature, e.g. the sink or the appliances, that should be added for the budget.

Furthermore, based on the estimates, the photos on the home design site can be filtered by their budget levels, e.g. high end, medium range, or low end.

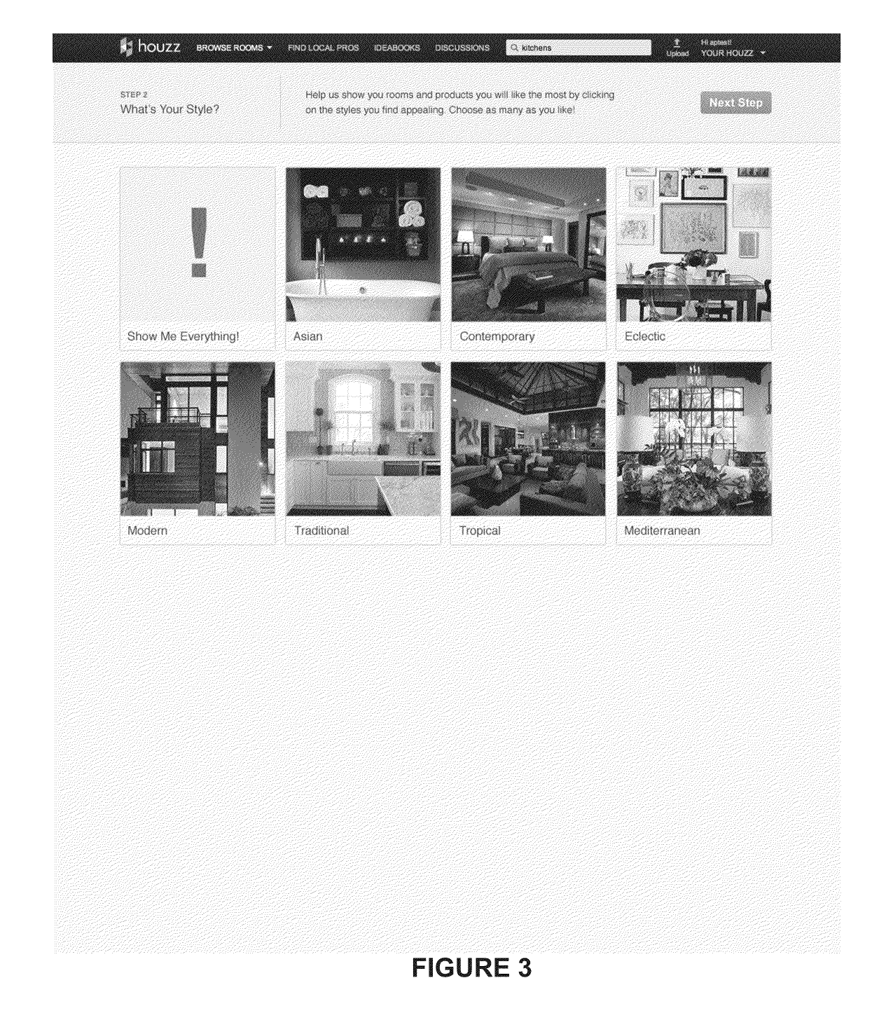

FIG. 3 is a screen shot showing a next step of a user dialog in which a user selects a style for use with the estimation tool according to the invention. In this example, the estimator tool drives the user to select a style, after which there are optionally more choices that the user goes through, such as choices of lighting, sinks, counters, walls, etc., as listed above

### Visualization

In embodiments of the invention, the estimator provides a visual representation of the costs per photo. In embodiments of the invention, such representation is accomplished, in embodiments of the invention, by overlaying the prices on top of the photo, or allowing the user to drill down into a part of the photo, and get detailed cost breakdown. The cost breakdown is provided by, for example, visualizing the budget components on the photos, on the side of the photos, in a spreadsheet, or along a spending timeline for the project.

For example, in embodiments of the invention detailed information about various features of the design can be provided by tagging items in the design. As shown in FIG. 2, there are green tags on several items. In FIG. 2, the tag on a lamp has been selected and information about the lamp is then provided. In this case, the lamp is a Harmon Pendant that costs $2465.00. Additional costs in connection with the lamp, such as installation and wiring are also shown. When reviewing the line items in the estimator, the user can decide to remove this lamp, for example, and the estimator then provides an updated estimate for the cost of the project.

In another example, a photo of the kitchen shows various features of the room, but the user is only interested in the range. A detailed close up of the range shows the estimated costs of products, e.g. range and hood, and labor, e.g. installation and gas piping, and ignores the rest of the costs of the room.

### Localization

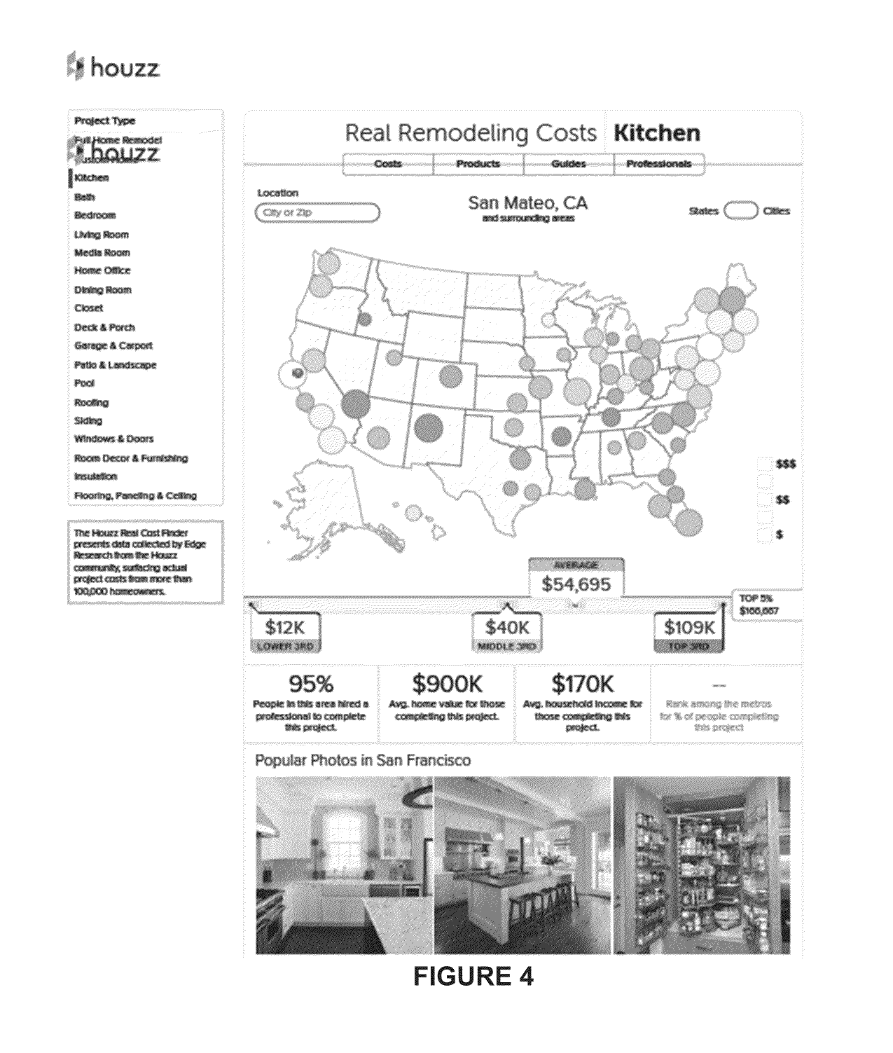

FIG. 4 is a screen shot showing localized design costs according to the invention. In embodiments of the invention, all pricing and estimates, specifically that of labor and material, are adjusted to the user's choice of location. This supports the variation of costs of, for example, the same kitchen being remodeled in San Mateo, Calif. vs. Phoenix, Ariz. The estimator applies a weighting factor to each appropriate item in a particular project based upon such localization.

The remodeling location informs the cost of remodeling because labor and regulations are different. As well, shipping costs for materials can affect such costs. The user has an option of setting the location of the remodeling project, thus affecting the final budget. FIG. 4 provides a rough estimate in large metropolitan areas around the U.S. Further drill down is available to get a better estimate in cities and neighborhoods. The adjusted remodeling costs estimate is based on statistical data obtained, for example, through research and/or user generated content, for cost of labor and city and county regulations.

### User Generated Content

In embodiments of the invention, professionals upload photos to the system. In embodiments of the invention, during the upload process there is a wizard which guides the professional through every photo, presenting a form to be filled. As the professional fills the form, additional details are requested. Thus, if the professional classifies the photo as a bath room, the professional is prompted for the types, materials, installation cost, and purchase cost of tiles, bathtub, sink, and vanity. Embodiments of the invention use such known techniques as input boxes, select boxes, auto-complete, as well as being able to apply the same or similar properties to a set of photos of the same room. In embodiments of the invention, professionals may provide, edit, and update the details and cost breakdown at a later time using similar guide-through wizards and specific forms.

The photo cost estimate is not limited to photos already stored on the design site platform. The user may upload a new photo into the design site and get help from the design site community to determine its remodeling cost. Members of the design site community, such as home remodeling professionals, vendors, and experienced users, provide their input about the various costs of the remodeling project shown in the photo, for example by applying their expertise and estimates to specific parts of the project.

Furthermore, if a user stumbles on a photo to their liking, which already exists in the system but which lacks a full cost breakdown, they can use the estimator tool to contact the photo's professional owner, and request that the owner add a further cost breakdown to the photo. Such interaction has an advantage for both parties because it initializes direct communication and the user is likely to contract a responsive professional who can guarantee the price.

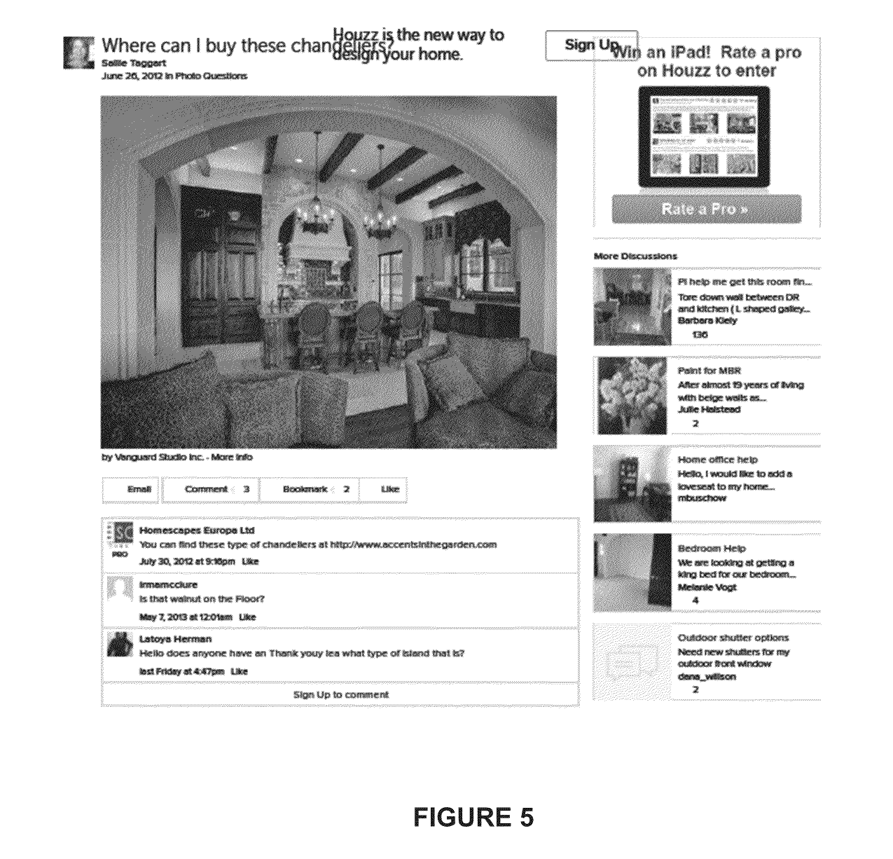

FIG. 5 is a screen shot that shows an example of user generated content as described above. As shown in FIG. 5, the user either picks an existing photo or uploads their own photo, and posts a question for further details. The photo illustrates how professionals and other users engage in answering the question, thus providing information pertaining to cost estimates and project planning.

### Project Bidding

The user can access the design site platform to obtain bids from home design professionals. At any given time, once the user has collected enough photos and marked substantial components that make up their remodeling estimate, the user is given an option to submit the breakdown of the project to a professional. In embodiments of the invention, submitting the project for bidding is part of the menus in the system, or it could be a button or a final step in a wizard. Significantly, the list of components that comprise a remodeling cost can be presented in a meaningful way to a potential professional who can review the project, interact with the user, and offer a bid.

The professional is informed about a remodeling appraisal via email or notification on the website (or App). On the site (or App), the professional can review what the user has curated, e.g. the inspiration photos, the selection of products, the choices of treatments and products, etc. The professional can also review and inspect the cost breakdown. The professional can also use the app to interact with the estimate by adding notes and comments. The professional can also submit a bid in a form which is forwarded to the user.

This integrates the refined cost estimate provided by the estimator with the design site community of professionals. Conversely, professionals who are registered on the design site can use the estimator to prepare their own cost offers for performing the remodeling, and/or send in their cost offers to users who express an interest in a particular photo.

For example, the user finds a photo on the design site for a remodel that is estimated at $20 k. The user submits this estimate to the community of professionals, possibly those in the user's metropolitan area, who can review the detailed break down and provide their own price quote, possibly including cost saving suggestions. Conversely, a professional who created a cost estimate can publish it on a design site profile and attract potential customers.

### Project Follow Up

The estimator tool offers a refined breakdown of the remodeling project. The choices that are made by the user accumulate and thus inform a detailed data set, including products, materials, measurements, city regulatory data, lists of vendors and service providers, time estimates, and dependencies.

In embodiments of the invention, the data collected drives a summary of charts and management tools, used to help the user in managing and tracking their project. The data is presented to the user by means of project Gantt charts, timeline, expense plan, orders plan, etc

### Ongoing Cost Tracking and Notification

The product and material pricing of the estimator are subject to live changes. As such, the design site platform monitors available online and retail pricing for products, materials, etc. The user can watch the cost of a room and receive notifications when its price drops below certain level. Similarly, changes to construction prices, e.g. due to economy or time of year, are tracked and notified.

### Remodeling Project Wizard

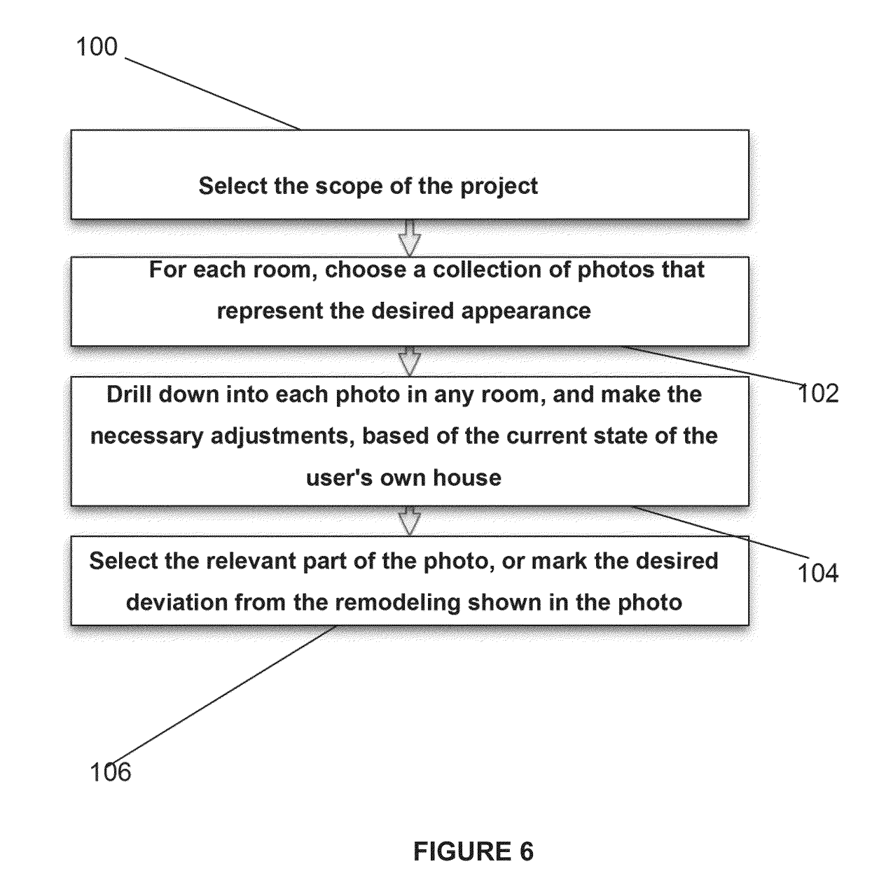

FIG. 6 is a flow diagram showing the use of an estimation tool according to the invention. The design site platform can take users through an online wizard, assisting them in quickly creating a detailed outlook of their forthcoming remodeling project. The design site remodeling project wizard takes the user through several steps, in which the entire project is constructed:

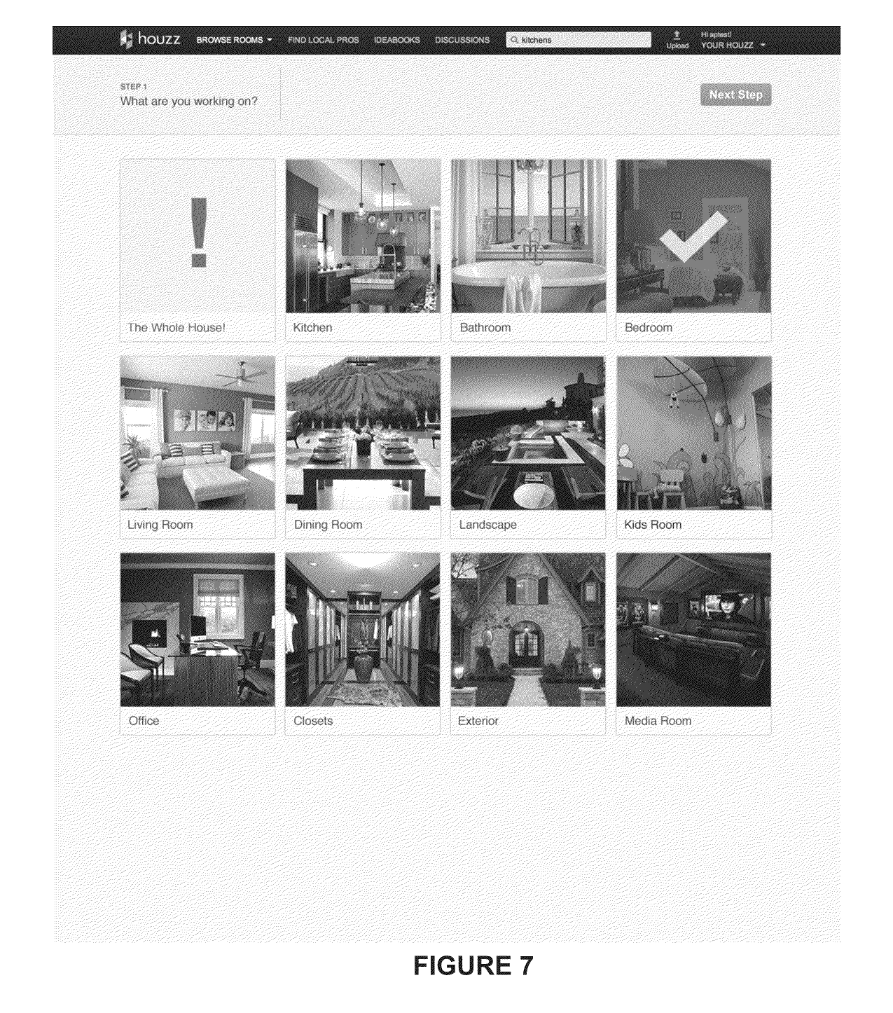

1. The user selects the scope of the project (100), i.e. which rooms are included, the budget range, the time range, etc. FIG. 7 is a screen shot showing a first step of a user dialog in which a user selects a room for use with the estimation tool according to the invention.
2. For each room, the user chooses a collection of photos that represent the desired appearance (102).
3. The user selects a photo. The user can drill down into each photo in any room, and make the necessary adjustments, based of the current state of the user's own house (104).
4. The user selects the relevant part of the photo, or marks the desired deviation from the remodeling shown in the photo (106).

FIG. 8 is a screen shot showing a user dialog in which a user selects a budget for use with the estimation tool according to the invention. In embodiments of the invention, photo data is entered either through manual curation or automatic identification. For example, the user has set a budget having a price range of $20 k-$30 k for remodeling a kitchen then the user is advised when the project cost exceeds this budget, for example by a visual indication or notification, as determined, for example, by the user's preset preference.

FIG. 9 is a screen shot showing a next step of a user dialog in which a user is presented with photos for selection in connection with use of the estimation tool according to the invention.

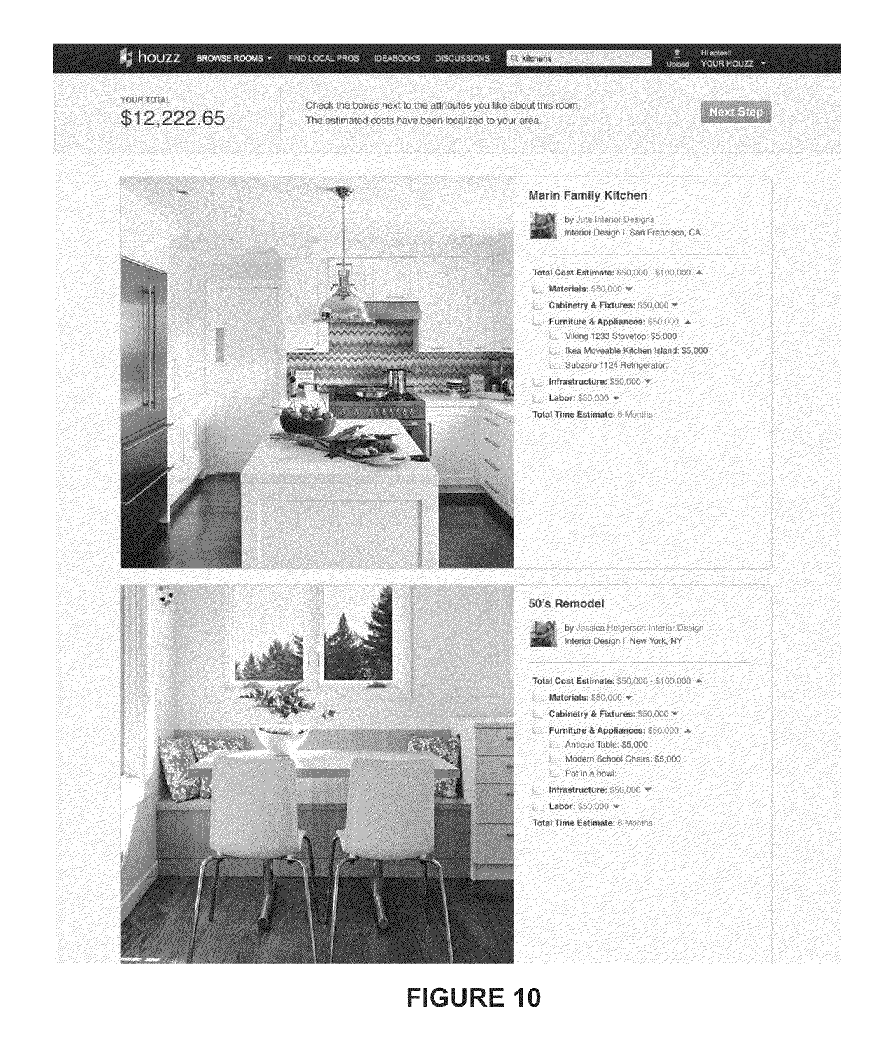

FIG. 10 is a screen shot showing a next step of a user dialog in which a user selects desired elements of a design depicted in a selected photo for use with the estimation tool according to the invention. Users can drill down into the photos, as shown in FIG. 10, where a list of elements are shown in a tree-view along with check-boxes. This is a common way for the user to drill down and make selection. The result of running the wizard is a complete cost and time breakdown of the entire project.

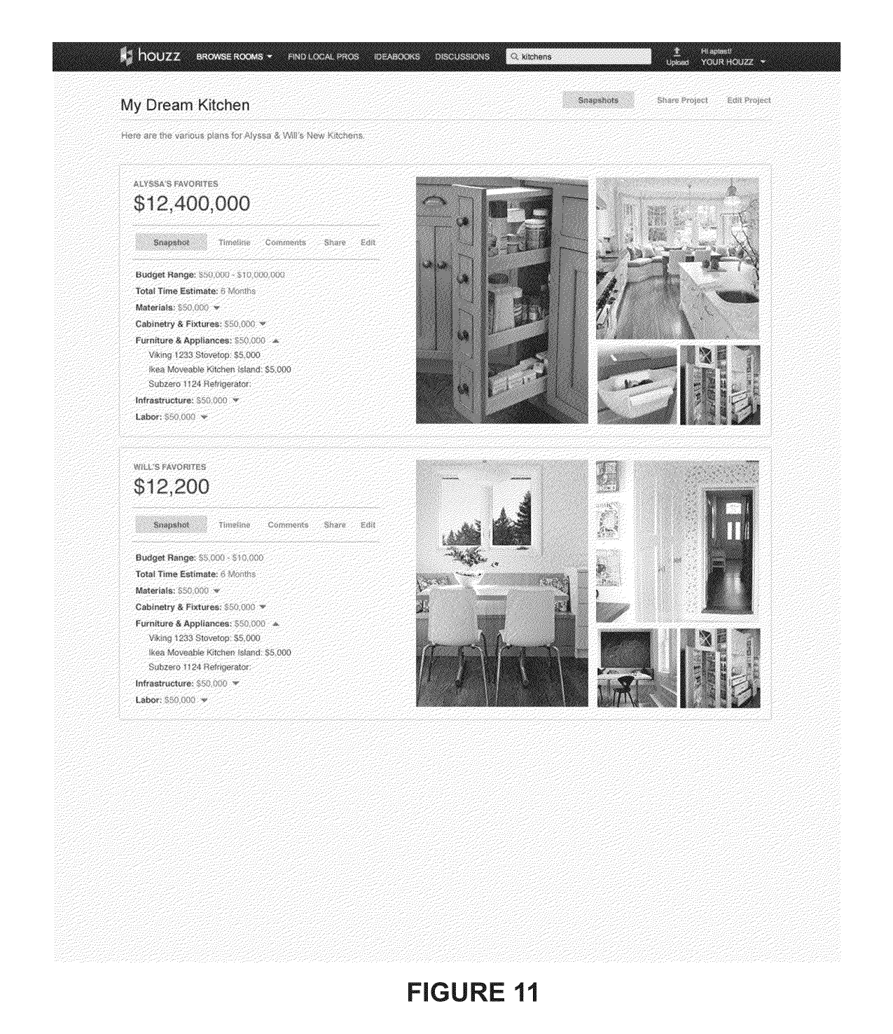

FIG. 11 is a screen shot showing an overview of how the project plan looks, thus providing a visually stimulating curation, along with a high-level cost breakdown, according to the invention. Additional views, e.g. Gantt, timeline, payment schedule, etc., can be triggered from this view.

At any given time, the user can go back to the project, drill down into its rooms and photos and alter their content, adjusting them to the user's real life situation. The user can replace products and materials with a more relevant alternative, or provide actual cost estimate offers from remodeling professionals. The project costs and timeline are adjusted accordingly.

### Computer Implementation

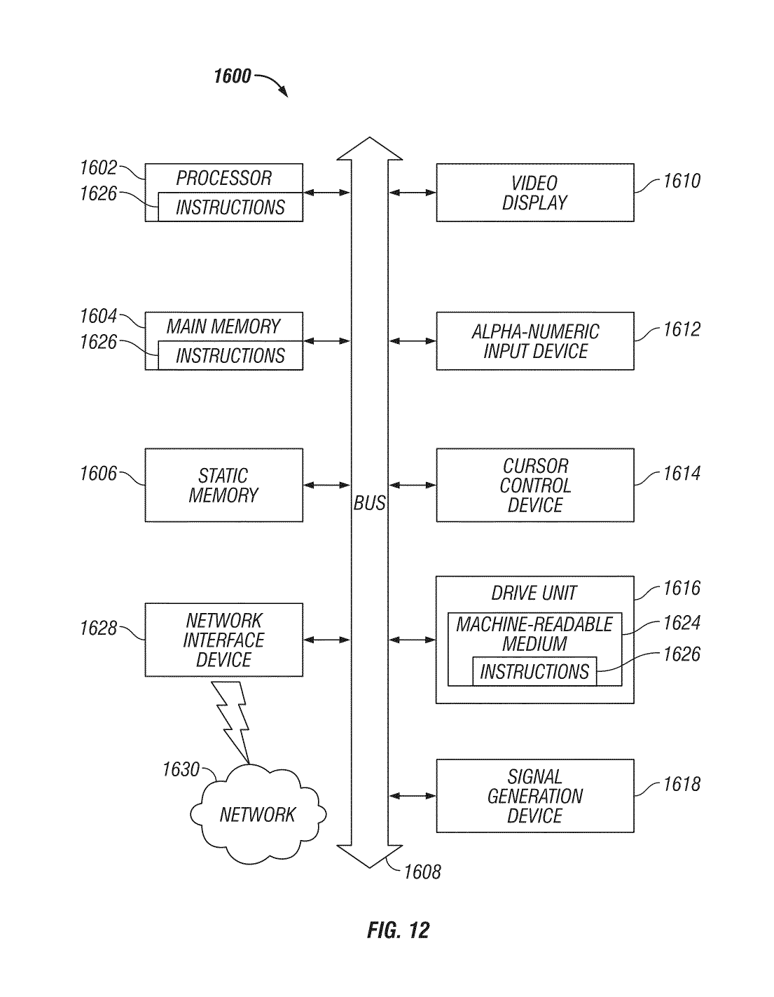

FIG. 12 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant, a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention.

For example, embodiments of the invention allow a user to choose between alternative remodeling plans, for example, where the homeowner is facing two, three, or more alternative remodeling solutions, each of which is acceptable and desirable, but each of which dictates a different approach and implies a different remodeling cost. Embodiments of the invention allow the user to compare two or more different plans by producing and estimating the plans in a straightforward fashion for side-by-side evaluation.

Accordingly, the invention should only be limited by the Claims included below.

1. A computer implemented remodel project estimation method, comprising:
with a processor, implementing an online estimator for creating a detailed outlook of a forthcoming remodeling project;
said estimator receiving user interactions defining a scope of said remodeling project comprising any of rooms included in the remodeling project, a budget range, and a time range;
for each room, said estimator receiving user interactions defining a collection of photos that represent a desired appearance for said remodeling project;
said estimator receiving user interactions drilling down into each photo in any room to make desired adjustments based of a current state of the user's own house;
said estimator receiving user interactions with a relevant part of a photo indicating a desired deviation from a design shown in said photo; and
responsive to said user interactions, said estimator providing a cost and time breakdown of said remodeling project.

2. The method of claim 1, further comprising:
at any given time, said estimator receiving user interactions with regard to said remodeling project to drill down into any of rooms and photos of said remodeling project, to alter content of any of said rooms and photos of said remodeling project, and to adjust any of said rooms and photos of said remodeling project to the user's real life situation; and
responsive thereto, said estimator adjusting project costs and timeline accordingly.

3. The method of claim 1, further comprising:
said estimator receiving user interactions with regard to said remodeling project to replace products and materials with a more relevant alternative, or provide actual cost estimate offers from remodeling professionals; and
responsive thereto, said estimator adjusting project costs and timeline accordingly.
